(19) United States
(12) Patent Application Publication
(10) Pub. No.: US 2012/0002992 A1
(43) Pub. Date: Jan. 5, 2012

(54) COLOR IMAGE FORMING APPARATUS

(75) Inventors: Toru YAMAGUCHI, Tokyo (JP); Yasushi KOSHIMURA, Tokyo (JP); Daiki YAMANAKA, Sagamihara-shi (JP)

(73) Assignee: KONICA MINOLTA BUSINESS TECHNOLOGIES, INC., Tokyo (JP)

(21) Appl. No.: 13/170,884

(22) Filed: Jun. 28, 2011

(30) Foreign Application Priority Data
Jul. 1, 2010 (JP) 2010-150865

(51) Int. Cl. G03G 15/20

(52) U.S. Cl. 399/49; 399/67

(57) ABSTRACT

Provided is a low cost color image forming apparatus in which the density of the image having been fixed is optimally adjusted and jamming in the fixing device is prohibited. The toner adhering amount of each single color toner image to form a color toner image is controlled based on the density detection result of the yellow test toner image having been fixed and the degree of fixation is controlled base on the density detection result of the black test toner image having been fixed

This application is based on Japanese Patent Application No. 2010-150865 filed on Jul. 1, 2010, in Japanese Patent Office, the entire content of which is hereby incorporated by reference.

### BACKGROUND OF THE INVENTION

The present invention relates to a color image forming apparatus to from an image via an electrophotographic process.

### TECHNICAL FIELD

In the electrophotographic process, there is conducted density control to maintain a density of a toner image constantly without fluctuation due to changes of environment, material and apparatus. Such density control is that a patch image representing a test image is formed and a detected result of detecting a density of the patch image is fed back to image forming conditions such as charging, exposing, developing and transferring conditions. Also, in the electrophtographic process, after the toner image is formed on a recording material, the toner image is fixed on to the recording material through a heating process.

In accordance with development of high-quality image in the technical field of image forming via the electrophotographic process, glossiness control to control a glossiness of the fixed toner image have been conducted besides the density control of the toner image.

In the Patent Document 1: Japanese Published Unexamined Patent Application No. 2006-171104, it is suggested that by providing a density detection device (density sensor) to detect the density of the patch image after fixing or before fixing and a glossiness detection device (glossiness sensor) to detect the glossiness of the patch image after fixing, the glossiness of the toner image is controlled based on the detection result of the above detection devices.

In the Patent Document 2: Japanese Published Unexamined Patent Application No. 2006-267165, it is suggested that by providing a first measuring device (density sensor) to detect the density of a toner image of before fixing and a second measuring device (density sensor and glossiness sensor) to detect a reflected light amount from the toner image after fixing, image forming conditions and fixing conditions are controlled based on the detection results of the above detection devices.
In the Patent Document 1: Japanese Published Unexamined Patent Application No. 2006-171104
In the Patent Document 2: Japanese Published Unexamined Patent Application No. 2006-267165

In both the Patent documents 1 and 2, as the detection device to detect the glossiness of the toner image after fixing, there is used a glossiness sensor having a light emitting section to radiate light with respect to the toner image and a light receiving section to separately received the reflected light of the toner image as specular reflection light and diffused reflection light.

Since the above sensors are expensive, const of the image forming apparatus using the glossiness sensor is increased.

### SUMMARY

The present invention has one aspect to solve the above problems and an object of the present invention is to provide an image forming apparatus to accurately control the density of the toner image after fixing at low cost.

The above object can be achieved by the following structures.

Structure 1. A color image forming apparatus, having: an image forming section, having a plurality of image forming units to form a plurality of single color toner images including a yellow toner image and the black toner image, to form a color toner image by overlapping the plurality of the single color toner images on a recording material; a fixing device to fix the color toner images onto the recording material; a yellow density sensor to detect a density of the yellow toner image having been fixed; a black density sensor to detect a density of the black toner image having been fixed, and a control section to control the image forming section and the fixing section so as to form and fix a yellow test toner image and a black test toner image on the recording material, to control toner adhering amounts of the plurality of the single color toner images based on a detection result of a density of the yellow test toner image having been fixed on the recording material via the yellow density sensor, and to control the fixing device based on a detection result of a density of the black test toner image having been fixed via the black density sensor.
Structure 2. The color image forming apparatus of structure 1, wherein the image forming section further comprises an intermediate transfer member and a single color density sensor to detect densities of the single color toner images on the intermediate transfer member, and the control section controls the image forming units so as to form the plurality of single color test toner images on the intermediate transfer member, and controls the toner adhering amounts of the single color toner images based on detection results of the single color toner images via the single color density sensor.
Structure 3. The color image forming apparatus of structure 1, further comprising a post-processing apparatus to conduct reception processing of the recording material after fixing processing, wherein the yellow density sensor and the black density sensor are disposed at the post-processing apparatus.

Whereby, an image having an appropriate density of the image after fixing is formed and a low cost color image forming apparatus can be realized. Also, occurrence of jamming in the fixing device can be sufficiently inhibited.

### BRIEF DESCRIPTION OF THE DRAWINGS

FIG. 1 is an overall configuration view of a color image forming apparatus related to an embodiment of the present invention.

FIG. 2 is a block diagram of a control system of a color image forming apparatus related to an embodiment of the present invention.

FIG. 3 is a flow chart of a process to control density of an image after fixing by adjusting a toner adhesion amount and fixing temperature.

FIG. 4 is a flow chart showing detail of Step S1 in FIG. 3.

FIG. 5 is a flow chart showing detail of Step S2 in FIG. 3.

FIG. 6 is a flow chart showing detail of Step S3 in FIG. 3.

### DETAILED DESCRIPTION OF PREFERRED EMBODIMENTS

The present invention will be described with reference to embodiments of the present invention without the present invention being limited to the embodiments described thereafter.

### <Color Image Forming Apparatus>

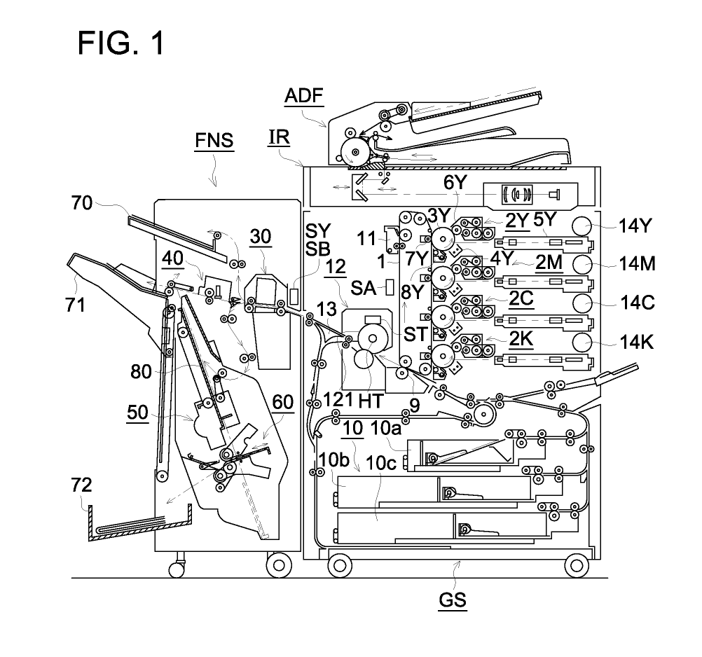

FIG. 1 is an overall configuration view of a color image forming apparatus related to an embodiment of the present invention.

The color image forming apparatus is configured with an image forming section GS and the post-processing apparatus FNS. The image forming apparatus GS has an intermediate transfer member 1 in a shape of an endless belt vertically wound in a middle thereof; and on a right side of the intermediate transfer member 1, there are disposed a plurality of image forming units to form single color images i.e. a yellow image forming unit 2Y, a magenta image forming units 2M, a cyan image forming units 2C and a black image forming units 2K in an order from the top.

The yellow image forming unit 2Y is provided with a photoconductive member 3Y, a charging device 4Y, an exposing device 5Y, a developing device 6Y, a first transfer roller 7Y and a cleaning device 8Y. In a circumference of the photoconductive member 3Y, the charging device 4Y, the exposing device 5Y, the developing device 6Y, the first transfer roller 7Y and the cleaning device 8Y are disposed subsequently in an anticlockwise direction. The photoconductive member 3Y and the first transfer roller 7Y are facing each other having the intermediate transfer member 1 in between.

The magenta image forming unit 2M is provided with a photoconductive member 3M, a charging device 4M, an exposing device 5M, a developing device 6M, a first transfer roller 7M and a cleaning device 8M. In a circumference of the photoconductive member 3M, the charging device 4M, the exposing device 5M, the developing device 6M, the first transfer miler 7M and the cleaning device 8M are disposed subsequently in an anticlockwise direction. The photoconductive member 3M and the first transfer roller 7M are facing each other having the intermediate transfer member 1 in between.

The cyan image forming unit 2C is provided with a photoconductive member 3C, a charging device 4C, an exposing device 5C, a developing device 6C, a first transfer roller 7C and a cleaning device 8C. In a circumference of the photoconductive member 3C, the charging device 4C, the exposing device 5C, the developing device 6C, the first transfer roller 7C and the cleaning device 8C are disposed subsequently in an anticlockwise direction. The photoconductive member 3C and the first transfer roller 7C are facing each other having the intermediate transfer member 1 in between.

The black image forming unit 2K is provided with a photoconductive member 3K, a charging device 4K, an exposing device 5K, a developing device 6K, a first transfer roller 7K and a cleaning device 8K. In a circumference of the photoconductive member 3K, the charging device 4K, the exposing device 5K, the developing device 6K, the first transfer roller 7K and the cleaning device 8K are disposed subsequently in an anticlockwise direction. The photoconductive member 3K and the first transfer roller 7K are facing each other having the intermediate transfer member 1 in between.

Incidentally, in FIG. 1, the symbols of the photoconductive members, the exposing devices, the developing devices, the first transfer rollers, and the cleaning devices for the magenta image forming unit, the cyan image forming unit, and the black image forming unit are omitted.

Between the automatic document feeding apparatus ADF and the intermediate transfer member 1, an image reading section IR is disposed so as to read out an image of the document fed to a reading position via the automatic document feeding apparatus ADF or an image of a document placed on a document glass.

In the yellow image forming unit 2Y, after the photoconductive member 3Y is charged evenly by the charging device 4Y, the photoconductive member 3Y is exposed by the exposing device 5Y and an electrostatic latent image is formed on the photoconductive member 3Y. The above electrostatic latent image becomes a yellow toner image by the developing device 6Y and transferred to the intermediate transfer member 1 via the first transfer roller 7Y. In the same manner, in the magenta image forming unit 2M, the cyan image forming unit 2C and the black image forming unit 2K, each of the single color toner images of magenta, cyan and black is transferred to the intermediate transfer member 1. On the intermediate transfer member 1, the single color toner images of yellow, magenta, cyan and black are overlapped and a color toner image is formed.

The color toner image formed by overlapping the plurality of the single color toner images on the intermediate transfer member 1 is transferred by the second transfer roller 9 onto a recording material fed from any one of sheet feeding tray of the sheet feeding apparatus 10. The intermediate transfer member 1 after transferring is cleaned by a belt cleaning device 11.

The color toner image transferred onto the recording material is subject to a heat treatment in the fixing device 12 to be fixed. At a downstream side of the fixing device 12, a conveyance path changeover member 13 indisposed so as to change whether the recording material is sent to a post-processing apparatus FNS or is conveyed downward to a both side printing conveyance path. The recording material conveyed to the both sides printing conveyance path is sent to the transfer position again and an image is formed on a reverse surface.

Circles on a right side in the FIG. 1 show toner supply bottles 14Y, 14M, 14C and 14K. Each of the toner supply bottles are to supply the toner via unillustrated conveyance devices to the developing devices 6Y, 6M, 6C and 6K, and can be replaced by opening a lid on a side section of the image forming apparatus when the toner runs out.

The sheet feeding device 10 is provided with a three-stage sheet feeding tray having trays 10a, 10b and 10c which stores sheets different in sheet size, sheet thickness and sheet kind.

The post-processing apparatus FNS is provided with four post-processing units i.e. a punching processing section 30 to form a punched hole on the recording material, a shift processing section 40 to shift the sheets in a direction perpendicular to the sheet conveyance direction by a predetermined unit of the sheets, a stapling processing section 50 to carry out stapling and a folding processing section 60. As sheet discharging trays, a fixed sheet discharging tray 70, a hoisting sheet discharging tray 71 and a lower sheet discharging tray 72 are provided.

The recording material conveyed from the image forming apparatus main body GS, goes through the punching processing section 30 via an entrance of the post-processing apparatus FNS. The recording material goes upward and is discharged to the fixed sheet discharging tray 70, passes through the shift processing section 40 and is discharged to the hoisting sheet discharging tray 71 or going downward and is stacked on a recording material stacker 80.

When a predetermined number of the sheets are stacked on the recording material stacker 80, the sheets are subject to stapling process by the stapling processing section 50. The stapling processing is capable of flat stitching and saddle stitching. After completion of the stapling processing, the stitched recording material bundle is ejected onto the hoisting sheet discharging tray 71.

In case folding processing is assigned as a post-processing, the recording material bundles accumulated on the recording material stacker 80 proceed to the folding section 60 configured with folding rollers and folding plates to be subject to center folding or tri-folding, then discharged to the lower sheet discharging tray 72. Also, in case of saddle stitching, the recording material is subject to saddle stitching and then subject to center folding.

The color image forming apparatus is provided with the following sensors.

Density Sensor SA (Single Color Density Sensor)

A density sensor SA is disposed between the secondary transfer position, where the secondary transfer roller 9 is disposed, and the belt cleaning device 11 so as to detect the density of a patch image formed on the intermediate transfer member 1. As described later, on the intermediate transfer member 1, there are formed patch images configured with single color toner images of yellow, magenta, cyan and black representing single color test toner images so that the density of single color toner images are detected.

The density sensor SA representing the single color density sensor is provided with an infrared LED as a light source. By radiating the infrared light onto the intermediate transfer member, a light receiving element receives reflected light from the patch image on the intermediate transfer member 1 so as to detect the density of the patch. As described in the forgoing, on the intermediate transfer member 1 the yellow patch image, the magenta patch image, the cyan patch image and the black patch image are formed. Through the density detection using the infrared light, the densities of the plurality of the single color patch images can be detected by the single density sensor SA.

Density Sensor SY (Yellow Density Sensor)

The density sensor SY is disposed at a recording material receiving section of the post-processing apparatus FNS. The density sensor SY detects the density of the yellow patch image formed and fixed on the recording material.

Density Sensor SK (Black Density Sensor)

The density sensor SK is disposed at a recording material receiving section of the post-processing apparatus FNS. The density sensor SK detects the density of the black patch image formed and fixed on the recording material.

The density sensor SY and the density sensor SK are disposed in parallel on a line perpendicular to the recording material conveyance direction. The yellow patch image and black patch image are formed in parallel at positions corresponding to the density sensor SY and the density sensor SK. The density sensor SY detects the yellow patch image and the density sensor SK detects the black patch image. Incidentally, the density sensor SY and the density sensor SK can be combined into one density sensor. Namely, through a yellow filter, the light receiving element of the density sensor receives the light so as to detect the density of the yellow patch, and without using the filter, light receiving element of the density sensor receives white light to detect the density of the black patch image.

As described later, on the recording material, there are formed the yellow patch image representing the yellow test toner image configured with yellow toner image for detecting density and the black patch image representing the black test toner image configured with the black toner image for detecting density.

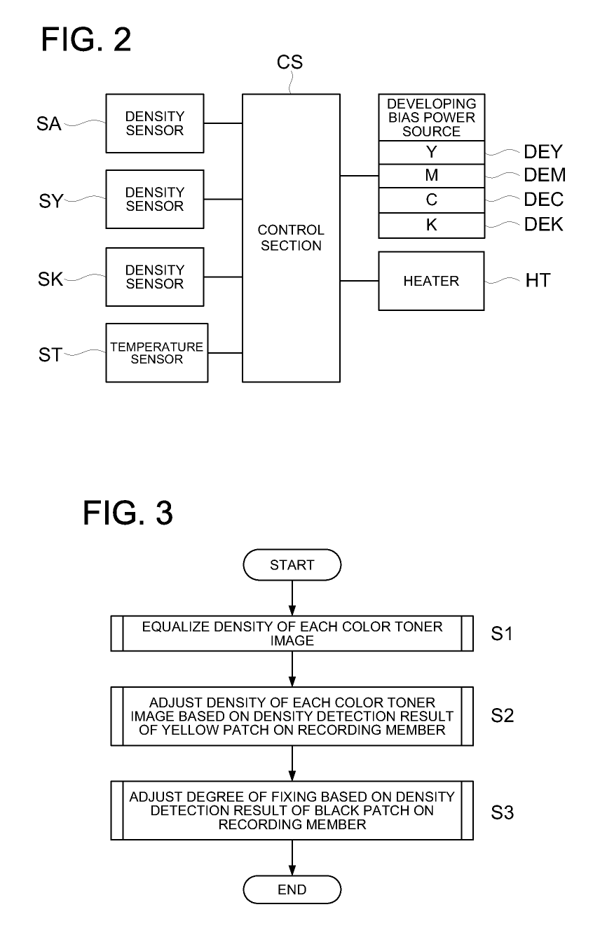

FIG. 2 is a block diagram of a control system to conduct image density control.

The control section CS controls the density of the image based on detected results of the density sensor SA and the density sensor SY. Control of the image density is conducted by adjusting process conditions of the image forming process so as to adjust the toner adhering amount. As the conditions to be adjusted, a charging voltage of the photoconductive member, a developing bias current (in particular a direct current element of the developing bias current), a ration of liner speed of the developing agent carrying member to liner speed of the photoconductive member, and a transfer condition (in particular a transfer current). In the following embodiment to be described, the toner adhesion amount is controlled by adjusting the direct current element of the developing bias current. Namely, by respectively controlling a developing bias power source DEY of the developing device 6Y, a developing bias power source DEM of the developing device 6M, a developing bias power source DEC of the developing device 6C and a developing bias power source of the developing device 6K, each toner adhesion amount of each single toner image is controlled. By controlling each toner adhesion amount, the density of each image is controlled.

In the control of the image density based on the detection results of the density sensor SA, the density of each of single color toner images, yellow, magenta, cyan and black is controlled separately. Contrarily, in the control of the image density based on the detection results of the density sensor SY, densities of the single color toner images, yellow, magenta, cyan and black are controlled comprehensively. For example, in case of the control by adjusting the developing bias, the developing bias of each single color is adjusted by changing the value of voltage equally.

In the control of the image density by adjusting the second transfer conditions, the image density is controlled by adjusting the transfer ratio equally for the yellow toner image, the magenta toner image, the cyan toner image and the black toner image. Therefore, by conducting the image density control based on the detection result of the density sensor SY by adjusting the second transfer conditions, the detection result of the density sensor SY is reflected commonly for the density of each single color image.

The control section CS also controls a degree of fixation based on the detection result of the density of the black patch image. Namely, the control section CS controls the fixing device 12 by controlling fixing temperature so as to control the degree of fixation. Fixing temperature control maintains a constant fixing temperature by turning on and off a heater HT based on the detection result of the temperature sensor ST, which detects temperature of a fixing roller 121 (refer to FIG. 1). In the above fixing temperature control, the control section CS changes a control level of turning on and off of the heater HT bases on the detection result of the density sensor SK so that the detection result of the density sensor is reflected to the degree of fixation by changing the fixing temperature.

<Control of Image Density>

The density of the image formed on the recording material having been fixed correlates with the toner adhering amount representing a toner amount forming the image, also besides the toner adhering amount, the density of the image having been fixed correlates with the degree of fixation of the image. Namely, an image having a high degree of fixation and a smooth surface shows a high density even if the toner adhering amount is the same, and an image having a low degree of fixation and a rough surface shows low density. Therefore, in order to form an image of an optimum density, the degree of fixation has to be controlled besides the toner adhering amount.

In a conventional technology, the image density has been controlled by adjusting the toner adhering amount. Thus according to the conventional technology, in case a desired image density can not be achieved due to asperity of the surface, the desired density has been achieved by increasing the toner adhering amount.

In case the image density is controlled only by the toner adhering amount as above, the toner adhering amount becomes excessive and a problem occurred in the image forming process. Namely, there is occurred jamming that the recording material winds around the fixing member in the fixing device.

The present invention has one aspect to solve the above problem by controlling the degree of fixation as well as the toner adhering amount as described below.

In the control of the toner adhering amount and the degree of fixation, the yellow patch image representing the yellow test toner image formed with yellow toner and the black patch image representing the black test toner image formed with black toner are used as described subsequently.

In the color image forming by the electrophotographic process, there are formed the plurality of the single color toner images configured with the single color toners i.e. yellow, magenta, cyan and black.

In a study of each single color toner, it was revealed that in the yellow toner image, an effect level for the degree of fixation to the image density is extremely low and in the black toner image the effect level for the degree of fixation to the image density is high.

As described in the forgoing, in order to make the density of the image having been fixed optimum, control of the toner adhering amount and control of the degree of fixation are necessary. Thus, by using aforesaid characteristics of the yellow toner image and the black toner image, an image having optimum density was formed and occurrence of jamming was sufficiently inhibited.

Summary of the above control is as follow.

By reflecting the detection result of detecting the density of the yellow patch image having been fixed with respect to adjustment of the toner adhering amount representing the toner amount configuring the image and by reflecting the detection result of detecting the density of the black patch image having been fixed with respect to adjustment of the fixing temperature which controls the degree of fixation, an image having an optimum density was formed. Also, the above image was formed with an optimum amount of toner, and jamming in the fixing device was effectively prohibited.

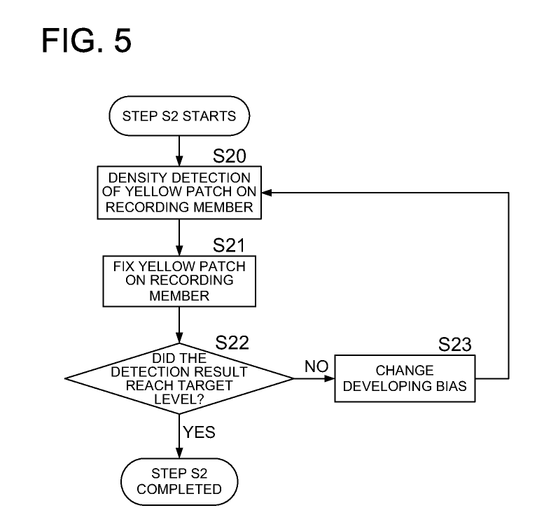

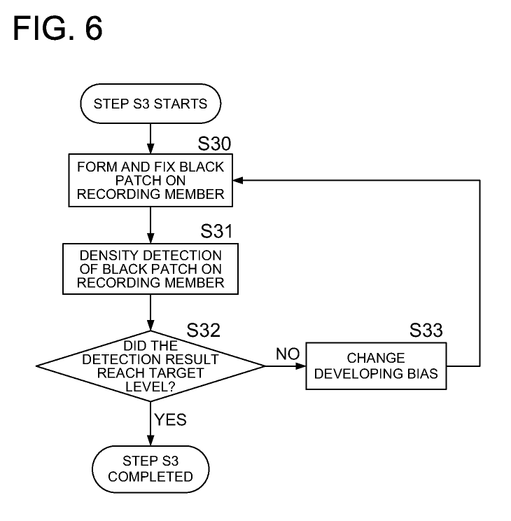

With reference to FIGS. 3 to 6, there will be described a process to control the density of the image having been fixed by adjusting the toner adhering amount and the fixing temperature.

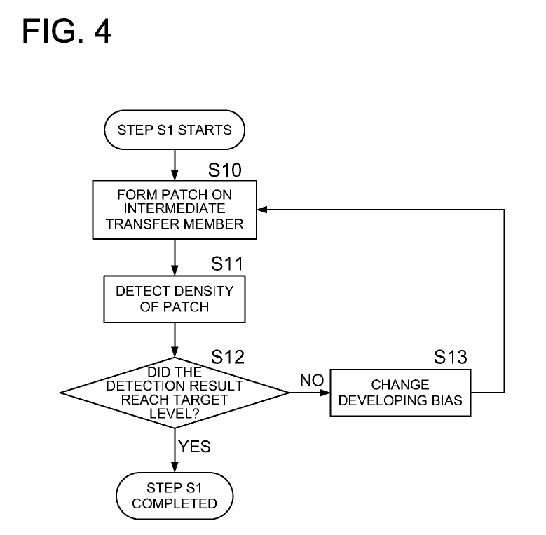

FIG. 3 shows a main routine of control in an embodiment of the present invention, and FIGS. 4 to 6 show detail of each step in FIG. 3.

In Step S1, control to equalize density of each single color toner image i.e. yellow, magenta, cyan and black is carried out.

In Step S2, based on the result detected from the density of the yellow patch image by the density sensor SY, the toner adhering amount of each single color toner image i.e. yellow, magenta, cyan and black is controlled.

In Step S3, base on the detection result of the density of the black patch image, the degree of fixation is controlled.

Steps S10 to S13 show the details of Step S1.

In Step S10, the single color patch images representing the single color test toner images, i.e. yellow, magenta, cyan and black are formed on the intermediate transfer member 1. As the patch image, a patch image having a maximum density, namely a so-called solid patch image is formed.

In Step S11, the density sensor SA detects the density of each single color patch image i.e. yellow, magenta, cyan and black.

In Step 12, whether or not the density is at a target level is judged. In case the density is not at the target level, the developing bias is changed in Step S13. In case the density is at the target level in Step 12, the process is terminated.

Steps S11 to S13 are for control of each single color toner image where the developing bias power source DEY is controlled based on the detection result of the yellow patch image, the developing bias power source DEM is controlled based on the detection result of the magenta patch image, the developing bias power source DEC is controlled based on the detection result of the cyan patch image and the developing bias power source DEK is controlled based on the detection result of the black patch image.

In Steps S20 to S23, the detail of Step S2 is described.

In Step S20, the yellow patch image representing the yellow test toner image is formed and fixed on the recording material.

In Step S21, the density sensor SY detects the density of the yellow patch image fixed on the recording medium.

In Step S22, whether or not the detected density is at the target level is judged.

In case the detected density is at the target level, the process is terminated, and the detected density is not at the target level, the developing bias is changed in Step S23. The developing biases are changed by controlling the developing bias power sources DEY, DEM, DEC and DEK. In the adjustment of Step S23 where the developing biases in the plurality of the developing devices to form respective single color toner images are adjusted, the amounts of the adjustment are equal for respective developing bias power sources DEY, DEM, DEC and DEK. However, it is possible that by determining relations among the adjusting amounts of respective developing devices in advance, adjustment is conducted in the predetermined relations, instead the adjustment is carried out under the condition where the adjusting amounts are equal. By the above adjustments, the toner amounts to form respective single color images can be set optimally. Incidentally, instead of changing the developing bias, the secondary transfer current can be changed as in the above manner.

In a loop of Steps S21 to S23, the toner adhering amount of each single color image is optimally set.

Steps S30 to S33 describe the details of Step S3.

In Step S30, the black patch image is formed on the recording material.

In Step S31, the density sensor SK detects the density of the black patch image fixed on the recording material.

In Step S32, whether or not the detected density is at the target level is judged.

In case the detected density is at the target level, the process is terminated, and if the detected density is not the target level the fixing temperature is changed in Step S23 so as to change the degree of fixation. Namely, In case the detected density of the black patch image is lower than a standard level, the fixing temperature is increased to increase the degree of fixation, and in case the detected density is higher than the standard level, the fixing temperature is decreased to decrease the degree of the fixation.

<Configuration and Experimental Conditions of Color Image Forming Apparatus>

Process speed (liner speed of the photoconductive member, intermediate transfer member and so forth): L/S=300/sec

Exposing light: Exposing device having laser light source

Developing: Two-component developing method

Photoconductive member: 60 mm at diameter, wherein a dispersion of phthalocyanine pigment dispersed in polycarbonate was coated as the organic semiconductor layer, and a film thickness of the photoconductive layer including a charge conveyance layer is 25 μm.

Cleaning device of photoconductive member: An urethane rubber member is in contact in a counter direction via spring force.

Photoconductive member drive motor: DC motor

Primary transfer device: A foamed roller (φ22, resistance: 10⁶Ω) is disposed on a back surface of the intermediate transfer member, and a predetermined current value is selected from a current value table where temperature and humidity and counter forms a matrix and applied. A roller diameter if the first transfer roller is φ22.

Belt tension of the intermediate transfer member: 6 kgf

Fixing: Fixing by a roller having a heater inside and a fixing

Intermediate transfer member: A seamless semiconductor resin belt (surface resistivity: 10¹¹Ω/□, volume resistivity: 10⁸ Ω·cm)

Secondary transfer device: Configured with the intermediate transfer member and the secondary transfer roller having a backup roller in between. Resistance values thereof are 10⁷Ω mutually, a predetermined current value (+ and − outputting available) is selected from a current value table where temperature and humidity and counter forms a matrix and applied. An outer diameter of the secondary transfer counter roller is φ24 and a nip width is 7 mm.

Density sensor SA: A specular reflection method density sensor fixed to be opposed to the intermediate transfer member

Density sensors SY and SK: A specular reflection method density sensor to measure the density on the recording material after fixing (It is actually a single sensor to detect the densities of the yellow patch image and the black patch image by switching the yellow filter).

Recording material: A matt coated sheet (POD matt coat)

### Embodiment

By carrying out the control shown by FIG. 3 to FIG. 6, the detection result of the density sensor SY was fed back to the developing bias to form each single color toner image i.e. yellow, magenta, cyan and black, and the detection result of the density sensor SK was fed back to the fixing temperature control.

### Comparison Example

After equalizing the density of each single color toner image via the control shown in FIG. 3 and FIG. 4, the density sensor detected the densities of the patch images of yellow, magenta, cyan and black having been fixed. Here, as the density sensor, a sensor having a RGB filter capable of detecting the density of each single color toner image i.e. yellow, magenta, cyan and black was used.

The detection result of each single color toner image was fed back to each developing bias to adjust the toner adhering amount.

In the present embodiment, an image of an optimum density was formed. Also, the jamming in the fixing device did not occur.

Contrarily, in the comparison example, since the toner adhering amount corresponding to the density detection result detected from a patch image formed on a matt surface of the recording material, an excessive toner adhering amount caused jamming.

In the present invention, the toner adhesion amounts of the single color toner images which from the color toner images is controlled based on the result of detecting the density of a yellow test toner image having been fixed, and the fixing device is controlled based on the result of detecting the density of the black color test toner image having been fixed.

What is claimed is:

1. A color image forming apparatus, comprising:
an image forming section, having a plurality of image forming units to form a plurality of single color toner images including a yellow toner image and the black toner image, to form a color toner image by overlapping the plurality of the single color toner images on a recording material;
a fixing device to fix the color toner images onto the recording material;
a yellow density sensor to detect a density of the yellow toner image having been fixed;
a black density sensor to detect a density of the black toner image having been fixed, and
a control section to control the image forming section and the fixing section so as to form and fix a yellow test toner image and a black test toner image on the recording material, to control toner adhering amounts of the plurality of the single color toner images based on a detection result of a density of the yellow test toner image having been fixed on the recording material via the yellow density sensor, and to control the fixing device based on a detection result of a density of the black test toner image having been fixed via the black density sensor.

2. The color image forming apparatus of claim 1, wherein the image forming section further comprises an intermediate transfer member and a single color density sensor to detect densities of the single color toner images on the intermediate transfer member, and the control section controls the image forming units so as to form the plurality of single color test toner images on the intermediate transfer member, and controls the toner adhering amounts of the single color toner images based on detection results of the single color toner images via the single color density sensor.

3. The color image forming apparatus of claim 1, further comprising a post-processing apparatus to conduct reception processing of the recording material after fixing processing, wherein the yellow density sensor and the black density sensor are disposed at the post-processing apparatus.

4. A color image forming method, comprising steps of:
forming a plurality of single color toner images including a yellow toner image and the black toner image;
forming a color toner image by overlapping the plurality of the single color toner images on a recording material;
fixing the color toner image onto the recording material;
detecting a density of the yellow toner image having been fixed;
detecting a density of the black toner image having been fixed, and
controlling an image forming section and a fixing section to form and fix a yellow test toner image and a black test toner image on the recording material,
controlling toner adhering amounts of the plurality of the single color toner images based on a detection result of a density of the yellow test toner image having been fixed on the recording material via a yellow density sensor, and
controlling a fixing section based on a detection result of a density of the black test toner image having been fixed via a black density sensor.

5. The color image forming method of claim 4, wherein the image forming section further comprises an intermediate transfer member and a single color density sensor to detect densities of single color toner images on the intermediate transfer member, and the control section controls the image forming units so as to form the plurality of single color test toner images on the intermediate transfer member, and controls the toner adhering amounts of the single color toner images based on detection results of the single color toner images via the single color density sensor.

6. The color image forming method of claim 4, wherein a post-processing apparatus, in which the yellow density sensor and the black density sensor are disposed, conducts reception processing of the recording material after fixing processing.
